(19) United States
(12) Patent Application Publication
(10) Pub. No.: US 2009/0052952 A1
(43) Pub. Date: Feb. 26, 2009

(54) IMAGE FORMING APPARATUS, PROCESS CARTRIDGE AND TONER

(76) Inventors: Hiroaki KATOH, Nagaokakyo-shi (JP); Naoki Nakatake, Nishinomiya-shi (JP); Hideaki Yasunaga, Ibaraki-shi (JP); Kazuoki Fuwa, Kawanishi-shi (JP); Yoshihiro Mikuriya, Nishinomiya-shi (JP); Masayuki Hagi, Mino-o-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/197,651

(22) Filed: Aug. 25, 2008

(30) Foreign Application Priority Data
Aug. 23, 2007 (JP) 2007-217151

(51) Int. Cl. G03G 15/08

(52) U.S. Cl. 399/284

(57) ABSTRACT

An image forming apparatus including an image bearing member including a tube, the image bearing member to bear a latent electrostatic image, a development device including a pulverized toner including a resin, a coloring agent and a releasing agent component, the development device to develop the latent electrostatic image with the toner to form a visualized image on the image bearing member, a transfer device to transfer the visualized image to a recording medium, a fixing device including a fixing member, the fixing device to fix the visualized image on the recording medium and an elastic blade to remove the toner on the surface of the image bearing member, wherein the toner has a void ratio of from 52 to 58% and a toner torque of from 1.0 to 2.5 mNm according to a torque measuring method using a circular conical rotor and the following relationships (1) to (4) are satisfied:

45≦WA≦60 Relationship (1)

2×WA−40≦50×T≦2×WA+5 Relationship (2)

1.2≦t≦2.0 Relationship (3)

40×T−70≦15×t≦40×T−22 Relationship (4)

where WA (%) represents a surface exposure amount of the releasing agent component of the toner, T (mNm) represents the toner torque at 58% of the void ratio and t (mm) represents a thickness of the tube.

### BACKGROUND OF THE INVENTION

1. Field of the Invention

The present invention relates to an image forming apparatus and a toner for use in the image forming apparatus.

2. Discussion of the Background

Electrophotography processes includes processes of charging, irradiation, development, transfer, fixing and cleaning and in the cleaning process, a blade cleaning system is typically employed.

Each process in the electrophotography is described in detail below.

A charging device uniformly charges the surface of a rotatable image bearing member (photoreceptor) (charging process) and an optical irradiation system irradiates the surface of the image bearing member with a laser beam (irradiation process) to form a latent electrostatic image on the image bearing member. Then, a developing agent including toner in a development unit is transferred to the surface of the image bearing member (development process) to form a visualized image thereon.

Next, the transfer device (roller) provided inside an intermediate transfer device transfers the developing agent to the surface of the intermediate transfer device at the contact portion between the intermediate transfer device and the image bearing member (transfer process). The transferred developing agent is transferred to a recording medium at the secondary transfer portion. The recording medium is conveyed to the fixing device where the toner is fixed on the recording medium (fixing process).

The developing agent remaining on the surface of the image bearing member is removed by the cleaning blade in the cleaning device (cleaning process).

The blade for use in blade cleaning includes a substrate and an elastic member having a board shape formed of polyurethane etc. attached to the substrate. The blade has a structure in which the blade is pressed in contact with the surface of the image bearing member. Thus, to improve the degree of cleaning performance for the surface of the image bearing member, it is desired to increase the contact pressure of the blade to the image bearing member. In addition, there are two contact states of the blade. One is that the blade is attached in the forward direction to the rotation direction of the image bearing member and the other is backward direction thereto. The latter is preferred in terms of the cleaning level and reduction of the pressure applied to the blade. Actually, almost all the image forming apparatuses employ the backward direction.

Also, a polymerized toner, which is manufactured by chemical treatment in aqueous medium instead of pulverization, has been developed in recent years. Such a polymerized toner is inexpensively manufactured and has a relatively uniform particle diameter and high average circularity in comparison with those of a polymerized toner, which helps to improve the quality of images.

However, the polymerized toner tends to be inferior with regard to the cleaning property so that the contact pressure from the elastic blade to the image bearing member is required to increase in comparison with the pressure in the case of the pulverized toner. Thus, there is a tendency that the releasing property between the toner and the surface of the image bearing member is improved by reducing the friction coefficient of the image bearing member to stabilize the cleaning effect. Consequently, there have been disclosed a number of methods which use the surface layer or the protective layer of an image bearing member containing a lubricant.

As such lubricants, for example, there are a fluorine atom containing resin such as polytetrafluoro ethylene, powder of resins such as an acryl resin and a polyethylene resin having a spherical form, and powder of metal oxides such as silicon oxides or aluminum oxides. Also, as a device to decrease the friction coefficient on a photoreceptor at the initial stage, an application system which applies toner or a lubricant near the contact portion between the elastic blade and the photoreceptor to form a lubricant layer on the surface of the photoreceptor has been already marketed.

There is another technology for improving the cleaning property, which uses a cleaning blade having a particular physicality or structure. In addition, it is also possible to reduce the vibration of the elastic blade and the photoreceptor at their contact portion, which is caused by the friction between the elastic blade and the photoreceptor, by arranging the physicality of the blade material. Thereby, the fluctuation in the ability of preventing toner slipping, squeaking and/or vibration of the elastic blade can be restrained. Therefore, an elastic blade formed of a blade material having a relatively low rebound resilience tends to be used.

However, in the case of a toner manufactured by adding a releasing component to a mother material to improve the separability (releasability) during fixing, it is confirmed that the toner tends to increase an attachment force thereof. Thereby, after a visualized image is formed on the image bearing member at the development portion and transferred to the transfer portion, the toner remaining on the image bearing member is prevented from slipping through at the contact portion of the cleaning blade and the image bearing member and thus is difficult to discharge, resulting in accumulation on the image bearing member. Furthermore, a pulverized toner, which has a low average circularity, is low in fluidity and easily accumulates.

When such toner pools increase at the contact portion of the cleaning blade and the surface of the image bearing member, the force of toner to slip through the cleaning blade is locally stronger than the force of the cleaning blade to prevent the toner from slipping through the cleaning blade. Therefore, a problem tends to surface that the toner slips through the contact portion, which causes bad cleaning. To remedy this bad cleaning problem, there is a method of dropping off accumulated toner by stick-slip phenomenon (minute vibration at the contact portion of a blade) of a high rebound resilient elastic blade. However, this method generates resonance of the minute vibration of the cleaning blade with the image bearing member, which leads to squeaking of the blade. In particular, this resonance tends to occur particularly to an inexpensive printer because the fixing of the cartridge portion thereof tends to be unstable in most cases.

### SUMMARY OF THE INVENTION

Because of these reasons, the present inventors recognize that a need exists for an image forming apparatus or a process cartridge which reduces the attachment force of toner and the amount of accumulated toner on the image bearing member to limit squeaking of the blade and have a good cleanability even when a pulverized toner having a low average circularity is used for image formation.

Accordingly, an object of the present invention is to provide an image forming apparatus or a process cartridge which reduces the attachment force of toner and the amount of accumulated toner to limit squeaking of the blade and have a good cleanability even when a pulverized toner having a low average circularity is used for image formation. Briefly this object and other objects of the present invention as hereinafter described will become more readily apparent and can be attained, either individually or in combination thereof, by an image forming apparatus including an image bearing member comprising a tube, the image bearing member to bear a latent electrostatic image, a development device including a pulverized toner including a resin, a coloring agent and a releasing agent component, the development device to develop the latent electrostatic image with the toner to form a visualized image on the image bearing member, a transfer device to transfer the visualized image to a recording medium, a fixing device including a fixing member, the fixing device to fix the visualized image on the recording medium, and an elastic blade to remove the toner on the surface of the image bearing member. In addition, the toner has a void ratio of from 52 to 58% and a toner torque of from 1.0 to 2.5 mNm according to a torque measuring method using a circular conical rotor and the following relationships (1) to (4) are satisfied:

45≦WA≦60 Relationship (1)

2×WA−40≦50×T≧2×WA+5 Relationship (2)

1.2≦t≦2.0 Relationship (3)

40×T−70≦15×t≦40×T−22 Relationship (4)

where WA (%) represents a surface exposure amount of the releasing agent component of the toner, T (mNm) represents the toner torque at 58% of the void ratio and t (mm) represents a thickness of the tube.

It is preferred that, in the image forming apparatus mentioned above, the toner has an average circularity of from 0.890 to 0.940.

It is still further preferred that, in the image forming apparatus mentioned above, the toner has a volume average particle diameter of from 5 to 10 μm.

It is still further preferred that, in the image forming apparatus mentioned above, the elastic blade includes an elastic body having a rebound resilience of from 40 to 80% at 25° C.

It is still further preferred that, in the image forming apparatus mentioned above, the contact portion of the elastic blade and the image bearing member has a linear pressure of from 20 to 30 N/m.

It is still further preferred that, in the image forming apparatus mentioned above, the toner is manufactured by melting, mixing and kneading a dry blend material as a raw material by a mortar type kneading machine followed by pulverization.

It is still further preferred that, in the image forming apparatus mentioned above, the releasing agent component is a resin including the releasing agent.

It is still further preferred that, in the image forming apparatus mentioned above, the releasing agent component is the releasing agent and the releasing agent is from 3 to 10 parts by weight based on 100 parts by weight of mother toner particles.

It is still further preferred that, in the image forming apparatus mentioned above, the toner includes an external additive having a primary particle diameter of from 10 to 50 nm.

It is still further preferred that, in the image forming apparatus mentioned above, the external additive is silica and has an attachment strength to the toner of from 30 to 80%.

It is still further preferred that, in the image forming apparatus mentioned above, the fixing device is a two roll fixing device including a heating roller and a pressing roller.

It is still further preferred that, in the image forming apparatus mentioned above, the fixing device is an oil free fixing device in which oil is not applied to the fixing member.

As another aspect of the present invention, a process cartridge is provided which includes an image bearing member including a tube, the image bearing member to bear a latent electrostatic image and an elastic blade to remove a toner on the surface of the image bearing member. In addition, the toner is a pulverized toner including a resin, a coloring agent and a releasing agent component and has a void ratio of from 52 to 58% and a toner torque of from 1.0 to 2.5 mNm according to a torque measuring method using a circular conical rotor and the following relationships (1) to (4) are satisfied:

45≦WA≦60 Relationship (1)

2×WA−40≦50×T≦2×WA+5 Relationship (2)

1.2≦t≦2.0 Relationship (3)

40×T−70≦15×t≦40×T−22 Relationship (4)

where WA (%) represents a surface exposure amount of the releasing agent component of the toner, T (mNm) represents the toner torque at 58% of the void ratio and t (mm) represents a thickness of the tube.

As another aspect of the present invention, an image formation method using the image forming apparatus mentioned above is provided.

As another aspect of the present invention, a single component toner for use in the image forming apparatus is provided.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a graph illustrating the relationship (2): 2×WA−40≦50×T≦2×WA+5;

FIG. 2 is a graph illustrating the relationship (4): 40×T−70≦15×t≦40×T−22;

FIG. 3 is a schematic diagram illustrating an example of the evaluation device for use in the present invention;

FIG. 4 is a schematic diagram illustrating an example of a circular conical rotor having a groove on its surface;

FIG. 5 is a schematic diagram illustrating how to attach a circular conical rotor to a torque meter;

FIG. 6 is a schematic diagram illustrating a structure of a printer as one of the embodiment of the image forming apparatus of the present invention;

FIG. 7 is an enlarged diagram illustrating a process unit or a development device for K(black) in the printer illustrated in FIG. 6;

FIG. 8 is an enlarged diagram illustrating the photoreceptor and the drum cleaning device in the process unit in the printer illustrated in FIG. 6;

FIG. 9 is an enlarged diagram illustrating the supporting board and the cleaning blade in the drum cleaning device in the printer illustrated in FIG. 6;

FIG. 10 is an enlarged diagram illustrating the front end of the cleaning blade and the photoreceptor in the printer illustrated in FIG. 6; and

FIG. 11 is a graph illustrating the relationship between the rebound resilience of an elastic blade and the friction coefficient of the surface of a photoreceptor.

### DETAILED DESCRIPTION OF THE INVENTION

The present invention will be described below in detail with reference to several embodiments and accompanying drawings.

The image forming apparatus of the present invention includes an image bearing member, a development device including toner which develops a latent electrostatic image on the image bearing member to form a visualized image, a transfer device to transfer the visualized image to a recording medium, a fixing device to fix the visualized image transferred to the recording medium, and an elastic blade having a board form to remove the toner remaining on the surface of the image bearing member. The toner is a pulverized toner including a resin, a coloring agent and a releasing agent component. In addition, the toner has a void ratio of from 52 to 58% and a toner torque of from 1.0 to 2.5 mNm according to a torque measuring method using a circular conical rotor and the following relationships (1) to (4) are satisfied:

45≦WA≦60 Relationship (1)

2×WA−40≦50×T≦2×WA+5 Relationship (2)

1.2≦t≦2.0 Relationship (3)

40×T−70≦15×t≦40×T−22 Relationship (4)

where WA (%) represents a surface exposure amount of the releasing agent component of the toner, T (mNm) represents the toner torque at 58% of the void ratio and t (mm) represents the thickness of the tube of the image bearing member.

When the tube of the image bearing member is too small, the dynamic stability of the image bearing member deteriorates. This increases the vibration, which makes squeaking of the cleaning blade in contact with the image bearing member louder. A tube of the image bearing member that is too large is heavy burden for a driving motor and thus increases the cost for boosting the performance of the motor and materials for the tube required corresponding to the size increase although the squeak of the cleaning blade is soothed. A toner friction (toner torque) measured by a circular conic rotor is too large easily contributes to vibrate the blade more violently when the toner accumulates near the blade during cleaning, which makes the squeak of the blade louder. By contrast, when a toner friction measured by a circular conic rotor is too small, the toner tends to slip, resulting in bad cleaning performance although the squeak of the cleaning blade is soothed. When the surface exposure amount of the releasing agent component (wax) is too large, the friction between toner particles increases, resulting in loud squeak. By contrast, when the surface exposure amount of the releasing agent is too small, the releasing agent component does not ooze sufficiently, resulting in occurrence of offset.

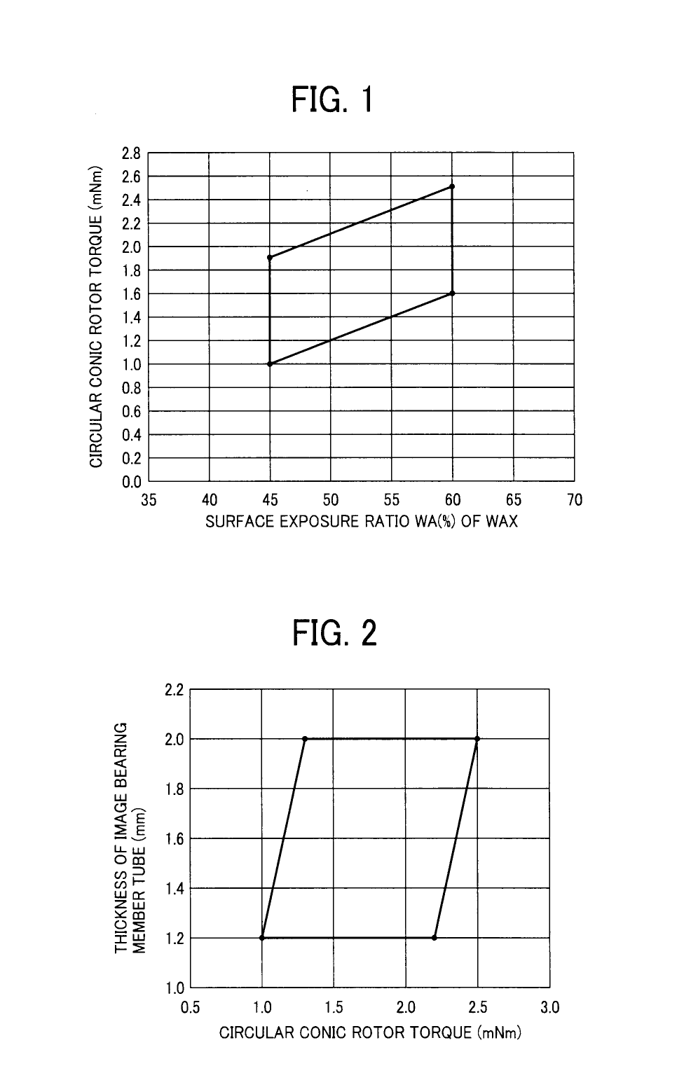

The relationships (2) and (4) are shown in FIGS. 1 and 2.

FIG. 1 is a graph illustrating the relationship between the surface exposure amount WA of the releasing agent component and the torque T. The area enclosed by four straight lines is an area of the preferable relationship between WA and T.

FIG. 2 is a graph illustrating the relationship between the torque T and the thickness t of the tube of the image bearing member. The area enclosed by four straight lines is an area of the preferable relationship between T and t.

### Measuring Method of Surface Exposure Amount WA (%) of Releasing Agent Component

Weigh 0.5 mg of toner (toner 1) before external additive treatment. Weigh 1.0 g before external additive treatment and add 7 ml of n-hexane followed by one minute stirring by a roll mill at 120 rpm. Suction-filter the solution and remove the liquid therefrom by vacuum drying. Weigh 0.5 mg thereof (toner 2). Heat the toners 1 and 2 to 200° C. using DSC6200 (manufactured by Seiko Instruments Inc.) followed by cooling down to 0° C. at a temperature descending speed of 10° C./min to obtain sample and measure the sample at a temperature rising speed of 10° C./min. According to the endothermic peak area, calculate the surface exposure amount X of the releasing agent component.

X=100−{(endothermic peak area of toner 2)/(endothermic peak area of toner 1)}×100

In this relationship, the endothermic peak area represents an area in the endothermic peak ascribable to the releasing agent component.

Circular Conic Rotor Method Fluidity Evaluation: Measuring Method of T (mNm)

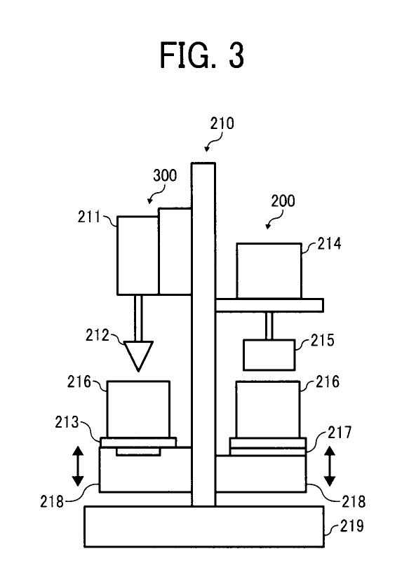

FIG. 3 is a diagram illustrating an example of the evaluation device for use in the present invention. The evaluation device is formed of a consolidation zone 200 and a measuring zone 300.

The consolidation zone 200 includes a sample vessel 216 to contain powder, a lifting stage 218 to lift up and down the sample vessel 216, a piston 215 for consolidation and a weight 214 to apply load to the piston 215.

In this structure example, the sample vessel 216 containing powder is lifted to be brought into contact with the piston 215 for consolidation and further lifted up until the weight 214 floats from a supporting board 219 to make the piston 215 under the full load of the weight 214. The structure is left for a predetermined time and thereafter the lifting stage 218 holding the sample vessel 216 containing powder thereon is moved down to detach the piston 215 from the surface of the powder.

The piston 215 can be formed of any material but the surface thereof to which the powder is pressed is preferred to be smooth. Therefore, an unaltered material easy to be processed is preferred while having a hard surface. In addition, it is desired to prevent the powder from attaching to the piston 215 due to charging. Therefore, an electroconductive material is suitable. Specific examples of such materials include SUS, Al, Cu, Au, Ag and brass.

In the present invention, the sample vessel 216 containing powder has an inner diameter of 60 mm and the height of the powder therein is from 25 to 28 mm when consolidation is complete.

The measuring zone 300 includes, as illustrated in FIG. 3, the sample vessel 216 containing powder, the lifting stage 218 to lift up and down the sample vessel 216, a load cell on the lifting stage to measure load, a torque meter 211 to measure the torque of the powder, etc. This structure example is merely an example and the present invention is not limited thereto.

A circular conic rotor 212 is attached to the front end of the shaft of the torque meter 211. The shaft is fixed in order not to move up and down.

The sample vessel 216 containing powder is structured to move up and down by the lift and placed on the center of the lifting stage 218. The circular conic rotor 212 penetrates in rotation into the center of the sample vessel 216 when the sample vessel 216 is lifted up.

The torque applied to the circular conic rotor 212 is detected by the torque meter 211 situated above the circular conic rotor 212. The load applied to the sample vessel 216 containing the powder is detected by the load cell 213 located below the sample vessel 216. The travel distance of the circular conic rotor 212 is detected by a position detector.

This structure is a mere example and can be applied to another structure in which the shaft itself can be moved up and down by the lifting stage 218.

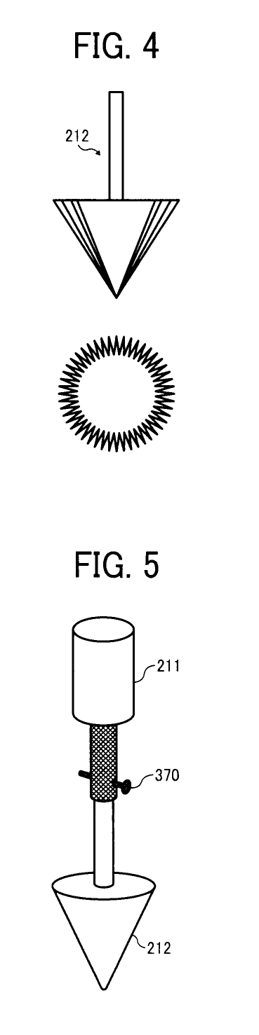

FIG. 4 is a diagram illustrating the circular conic rotor 212 having grooves on the surface thereof. The circular conic rotor 212 has an apex angle of 60° C. and grooves having the same form and depth are cut on the surface of the circular conic rotor 212 as illustrated in FIG. 4. The grooves are cut straight from the apex to the base and the cross section of the grooves has a sawtooth shape having triangle concavoconvex forms. The base of the circular conic rotor 212 has a diameter of 30 mm and the side has a length of 30 mm. The groove depth is 0 mm at the apex and gradually increases to 1 mm at the base. The number of the grooves is 48 (hereinafter referred to as the circular conic rotor I).

Not the friction component between the material surface of the circular conic rotor 212 and toner particles but the friction between toner particles is measured.

The contact between the material surface of the circular conic rotor 212 and toner particles occurs only at the tip of the thread of the triangular groove of the material surface of the circular conic rotor 212. Mostly contacts occur between toner particles trapped in the groove and toner particles therearound.

There is no limit to the material of the circular conic rotor 212. Any unaltered material easy to be processed with a hard surface is preferred. Furthermore, such a material without a charging property is more preferred. Specific examples of such materials include SUS, Al, Cu, Au, Ag and brass.

The fluidity of the powder of the toner is evaluated by measuring the torque or the load generated while the circular conic rotor 212 is moving in the powder phase when rotating to penetrate into the powder phase. In detail, the torque or the load applied to the circular conic rotor 212 or the sample vessel 216 containing the toner is measured when the circular conic rotor 212 penetrates (descends) in rotation into the toner powder phase and withdraws (ascends) therefrom. The fluidity of the toner is evaluated by the values of the torque or the load. The torque and the load of the toner powder vary depending on the rotation speed or the number of rotation per minute (rpm) (hereinafter referred to as the number of rotation), and the penetration speed of the circular conic rotor 212. To improve the measuring accuracy, the number of rotation and the penetration speed of the circular conic rotor 212 are decreased to be able to measure the subtle contact state between toner particles. Preferred measuring conditions are as follows:

### Measuring Conditions

Number of rotation of the circular conic rotor: 0.1 to 100 rpm
Penetration speed of the circular conic rotor: 0.5 to 150 mm/min

The actual measuring conditions of the present invention are as follows:
Number of rotation of the circular conic rotor: 1.0 rpm
Penetration speed of the circular conic rotor: 1.0 mm/min
Pressure to toner layer: at least 0.1 kg/cm² for at least 60 seconds
Form of the circular conic rotor: Circular conic rotor I

The torque or the load is small when the penetration distance of the circular conic rotor 212 is short, which causes a problem with the reproducibility of data. Therefore, it is desired to move the circular conic rotor 212 into an area in which the data reproducibility is secured. According to the results of the experiment made by the inventors, a penetration of 5 mm is sufficient to secure stable measurement.

In addition, the void ratio of the toner powder layer is considered. The void ratio is obtained by the following relationship:

ε=(V−M/ρ)/V

In the relationship, ε represents the void ratio, M represents the weight of the toner powder filled in the measuring container, ρ is the absolute specific gravity and V represents the volume of the toner layer.

Generally, toner is a mixture of toner particles and optional inorganic and/or organic additives such as silica and titanium oxide. The cleaning property is stabilized by adjusting the characteristics of the mixture in addition to the characteristics of the mother toner (i.e., mother toner particle). The additives such as silica are used to improve the fluidity of a toner. Improving the fluidity is equal to reducing the friction coefficient between toner particles and thus reducing the torque by the circular conic rotor 212 for use in the present invention.

It is good to have a high void ratio. According to the study on the results, when the void ratio is 52% or higher, a good cleanability is easily obtained. It is not clear about the relationship between the void ratio and the cleaning property but when the void ratio is too low, the density of the toner accumulating at the top of the cleaning blade tends to be high. Thereby, the toner pushes up the cleaning blade so that the toner easily slips through the cleaning blade. By contrast, when the void ratio is too high, the toner tends to float in the air, which may lead to contamination in the image forming apparatus due to this toner scattering.

In the present invention, the toner has a good cleaning property when the toner has a void ratio of from 52 to 58% and the rotation torque of the toner ranges from 1.0 to 2.5 mNm according to the torque measuring method described above when the circular conic rotor 212 penetrates into the toner to 20 mm. The mechanism of this is not clear. However, the toner accumulates around the contact portion of the cleaning blade and the image bearing member when the cleaning blade is in motion. When the accumulated toner contacts with the toner newly moved up by the rotation of the image bearing member and the friction between the toners is strong, it is considered that the toners are easily detached from the image bearing member. When the rotation torque is too low, the agglomeration force of the toner is small so that the toner easily scatters, which leads to contamination in the image forming apparatus. When the rotation torque is too high, the agglomeration force of the toner is strong so that it is difficult to clean the surface of the image bearing member, which leads to production of abnormal images, for example, on which the previous images remain.

FIG. 5 is a diagram illustrating the way how the circular conic rotor 212 is fixed onto the torque meter 211. As illustrated in FIG. 5, the fixing screw 370 is used to fix the circular conic rotor 212 onto the torque meter 211. Therefore, the circular conic rotor 212 made of a different material can be easily detachably attachable. Since the circular conic rotor 212 is detached and attached by one screw, the circular conic rotor 212 is easily replaced so that the fluidity of various kinds of materials and powder can be evaluated.

It is suitable to use a torque meter having a high sensitivity and employing non-contact type as the torque meter 211. The load cell 213 has a wide range of load and a high resolution power. The position detector employs a linear scale, a displaced sensor using light, etc. When it comes with the accuracy, a suitable specification is 0.1 mm or below. With regard to the lift, it is preferred to select a lift which can be accurately driven by using a servo motor or a stepping motor.

Next, the basic structure of the image forming apparatus of the present invention is described below.

The examples described below are suitable for the present invention and thus there are several preferable technical limitations to them. However, the present invention is not limited by these limitations unless otherwise specified.

### Image Forming Apparatus

As the image forming apparatus of the present invention, one example of an electrophotographic printer (hereinafter referred to as printer) is described below.

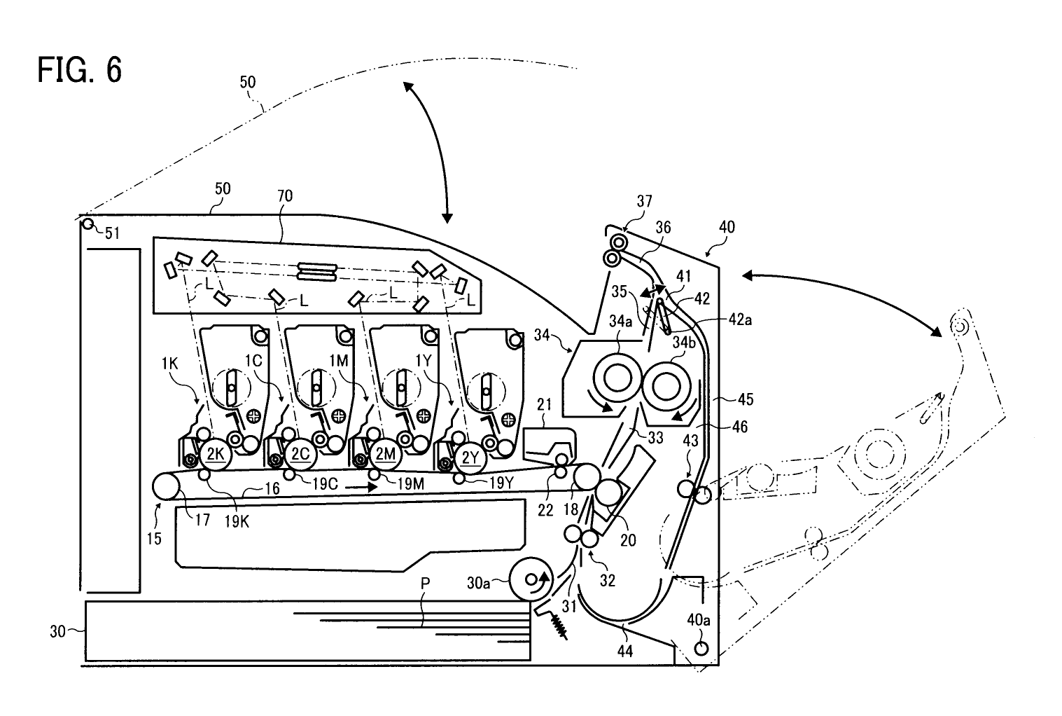

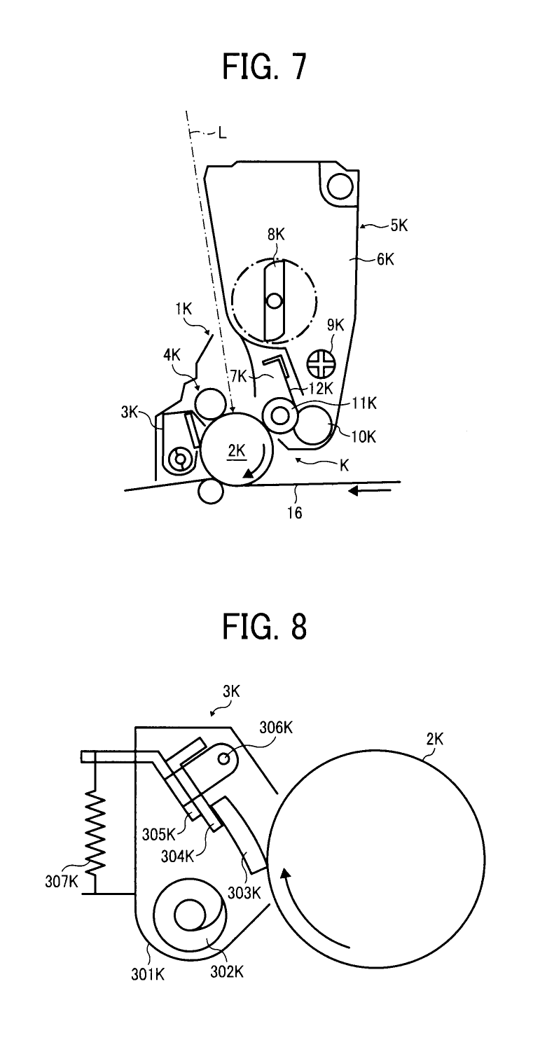

The basic structure of the printer is as follows. FIG. 6 is a schematic diagram illustrating the printer. In FIG. 6, the printer includes four toner image formation units to form yellow, magenta, cyan and black (hereinafter referred to as Y, M, C and K, respectively) toner images. These toner image formation units are formed of process units and development devices. The K toner image formation unit to form K toner images is taken as an example for description. As illustrated in FIG. 7, the process unit 1K for K and the development device 5K are included.

The process unit 1K for K includes a photoreceptor 2K having a drum form as an image bearing member, a drum cleaning device 3K, a discharging device (not shown), a charging device 4K, etc., all of which are supported by a casing. The process unit 1K is integrally detachable and attachable to the main body of the printer as one unit.

The photoreceptor 2K is rotated clockwise by a driving force (not shown). The charging device 4K uniformly charges the surface of the photoreceptor 2K rotationally driven. The surface of the photoreceptor 2K which is uniformly charged is irradiated with a laser beam L and bears a latent electrostatic image for K. The latent electrostatic image for K is developed by the development device 5K using K toner (not shown) to form a K toner image. Thereafter, the K toner image is intermediately transferred to an intermediate transfer belt 16. The drum cleaning device 3K removes the toner remaining on the surface of the photoreceptor 2K after the intermediate transfer process. In addition, the discharging device (not shown) discharges the charge remaining on the photoreceptor 2K after cleaning. By this discharging, the surface of the photoreceptor 2K is initialized and ready for the next image formation cycle. The same applies to the other color process units (1Y, 1M and 1C). Y, M, and C toner images are formed on the photoreceptors 2Y, 2M and 2C and intermediately transferred to the intermediate transfer belt 16.

The development device 5K includes a hopper 6K having an oblong form to accommodate K toner (not shown) and a development portion 7K. In the hopper 6K, there are provided an agitator 8K rotationally driven by a driving force (not shown), a stirring paddle 9K rotationally driven by a driving force (not shown) located below the agitator 8K in the vertical direction, and a toner supply roller 10K rotationally driven by a driving force (not shown) located below the stirring paddle 9K in the vertical direction. The K toner falls in the hopper 6K by its own weight to the toner supply roller 10K while the K toner is stirred by the rotation of the agitator 8K and the stirring paddle 9K. The toner supply roller 10K includes a roller portion formed of a cored bar made of metal and a resin foam coated thereon and rotates attaching the K toner in the hopper 6K to the surface of the roller portion.

In the development portion 7K in the development device 5K, there are provided a development roller 11K which rotates in contact with the photoreceptor 2K and the toner supply roller 10K, a thin layer forming blade 12K which contacts with the surface of the development roller 11K at the front end of the thin layer forming blade 12K. The K toner attached to the toner supply roller 10K in the hopper 6K is supplied to the surface of the development roller 11K at the contact portion of the development roller 11K and the toner supply roller 10K. The layer thickness of the K toner supplied is regulated at the contact portion of the development roller 11K and the thin layer forming blade 12K when the K toner passes through the contact portion while the development roller 11K rotates. The K toner after the layer thickness is regulated is attached to the latent electrostatic image for K on the surface of the photoreceptor 2K in the development area, i.e., the contact portion of the development roller 11K and the photoreceptor 2K. Thereby, the latent electrostatic image for K is developed to form the K toner image.

The K toner image formation portion is described with reference to FIG. 7. The same applies to the toner image formation portions for Y, M and C and thus the Y, M and C toner images are formed on the surface of the photoreceptors 2Y, 2M and 2C.

In FIG. 6 described above, an optical writing unit 70 is provided above the four toner image formation units. The optical writing unit 70 functioning as a latent electrostatic image writing device optically scans the photoreceptors 2Y, 2M, 2C and 2K in the process units 1Y, 1M, 1C and 1K, respectively, with the laser beam L emitted from a laser diode according to the image information. By the optical scanning, latent electrostatic images for Y, M, C and K are formed on the photoreceptors 2Y, 2M, 2C and 2K. The optical writing unit 70 irradiates the photoreceptor with the laser beam L emitted from the light source which is polarized in the primary scanning direction by a polygon mirror rotationally driven by a polygon motor (not shown) and by way of multiple optical lenses and mirrors.

Below the four toner image formation units, there is provided a transfer unit 15 which endlessly moves an endless intermediate transfer belt 16 clockwise in FIG. 6 while suspending the endless intermediate transfer belt 16. The transfer unit 15 includes a driving roller 17, a driven roller 18, four primary transfer rollers 19Y, 19M, 19C and 19K, a secondary transfer roller 20, a belt cleaning device 21 and a cleaning backup roller 22 in addition to the intermediate transfer belt 16.

The intermediate transfer belt 16 is suspended by the driving roller 17, the driven roller 18, the cleaning backup roller 22 and four primary transfer rollers 19Y, 19M, 19C and 19K which are located inside the loop of the intermediate transfer belt 16. The intermediate transfer belt 16 is endlessly moved counterclockwise in FIG. 6 by the rotation force of the driving roller 17 driven by a driving force (not shown).

The four primary transfer rollers 19Y, 19M, 19C and 19K and the photoreceptors 2Y, 2M, 2C and 2k sandwich the intermediate transfer belt 16 which endlessly moves. Thereby, each of the primary transfer nip for Y, M, C and K is formed at the contact portion of the front surface of the intermediate transfer belt 16 and the photoreceptors 2Y, 2M, 2C and 2K.

The primary transfer bias is applied to the primary transfer rollers 19Y, 19M, 19C and 19K by a transfer bias power source (not shown). Thereby, a transfer electric field is formed between the latent electrostatic images on the photoreceptors 2Y, 2M, 2C and 2K and the primary transfer rollers 19Y, 19M, 19C and 19K. A transfer charger or a transfer brush can be employed in place of the primary transfer rollers 19Y, 19M, 19C and 19K.

The Y toner image formed on the surface of the photoreceptor 2Y of the process unit 1Y advances into the primary transfer nip for Y described above as the photoreceptor 2Y rotates. Due to the transfer electric field and the nipping pressure, the Y toner is primarily transferred from the photoreceptor 2Y to the intermediate transfer belt 16. When the intermediate transfer belt 16 on which the Y toner image is primarily transferred passes through the primary transfer nips for M, C and K while the intermediate transfer belt 16 moves endlessly, the M, C and K toner images on the photoreceptors 2M, 2C and 2K are overlapped on the Y toner image sequentially. According to this overlapping of the primary transfer, the four color toner image is formed on the intermediate transfer belt 16.

The secondary transfer roller 20 of the transfer unit 15 is provided outside the loop of the intermediate transfer belt 16 and is in contact with the driven roller 18 situated inside the loop with the intermediate transfer belt therebetween. This is a portion of the secondary transfer nip where the front surface of the intermediate transfer belt 16 and the secondary transfer belt 20 contact with each other. The secondary transfer bias is applied to the secondary transfer roller 20 by a transfer bias power source (not shown). By this application, a secondary transfer electric field is formed between the secondary transfer roller 20 and the driven roller 18, which is grounded.

Below the transfer unit 15, there is provided a paper feeder cassette 30 which accommodates a bundle of sheets of recording paper P and is slidably attachable and detachable to the casing of the printer. The recording paper P situated on the top of the bundle in the paper feeder cassette 30 is in contact with a paper feeding roller 30a. The paper feeding roller 30a rotates counterclockwise in FIG. 6 at a particular timing to feed the recording paper P to a paper path 31.

Near the end portion of the paper path 31, there is provided a pair of registration rollers 32. This pair of registration rollers 32 suspends the rotation thereof immediately after the pair of registration rollers 32 nips the recording paper P between the rollers. The pair of registration rollers 32 resumes rotation at a timing of feeding the nipped recording paper P to the secondary transfer nip in synchronization with the four color toner image on the intermediate transfer belt 16.

The four color toner image on the intermediate transfer belt 16 which has been closely made contact with the recording paper P at the secondary transfer nip is secondarily transferred to the recording paper P at one time due to the secondary transfer electric field and the nipping pressure. Then, the four color toner image forms a full color toner image in combination with the color of white of the recording paper P. The recording paper P which has passed through the secondary transfer nip while carrying the full color toner image thereon curvature-separates from the secondary transfer roller 20 and the intermediate transfer belt 16. Thereafter, via a paper path 33 after transfer, the recording paper P is transferred to a fixing device 34. In this example, a typical secondary transfer system is employed in which a toner image is transferred from an image bearing member to a recording medium such as a transfer paper but it is also possible to adopt a primary transfer system in which a toner image is directly transferred from an image bearing member to a recording medium such as transfer paper. The present invention is not limited by the structure of the transfer system described above.

Toner that has not been transferred to the intermediate transfer belt 16 when the toner image passes through the secondary transfer nip portion remains on the intermediate transfer belt 16. This remaining toner is removed by the belt cleaning device 21 provided in contact with the front surface of the intermediate transfer belt 16. The cleaning backup roller 22 provided inside the loop of the intermediate transfer belt 16 assists the cleaning by the belt cleaning belt device 21.

The fixing device 34 forms a fixing nip by a fixing roller 34a internally including a heating source (not shown) such as a halogen lamp and a pressure roller 34b which rotates in contact with the fixing roller with a particular pressure. The recording paper P fed into the fixing roller 34 is nipped at the fixing nip with the unfixed toner image closely attached with the fixing roller 34a. Due to pressing and heating, the toner in the toner image is softened, resulting in fixing of the full color toner image.

The recording paper P discharged out of the fixing device 34 reaches the cross point of a paper discharging path 36 and a paper path 41 before reversing via a paper path 35 after fixing. There is provided a switching claw 42 on the side of the paper path 35 after fixing which is rotationally driven around a rotation axis 42a. Due to this rotation, the portion around the end of the paper path 35 after fixing is open and close. At a timing on which the recording paper P is discharged from the fixing device 34, the switching claw 42 stops at the rotation position indicated by the solid line in FIG. 6 to open the portion around the end of the paper path 35 after fixing. Therefore, the recording paper P advances into the paper discharging path 36 and is nipped between a pair of discharging rollers 37.

When a simplex mode which is controlled by an input to the operation portion by, for example, a ten key (not shown), a control signal sent from a home computer (not shown), etc. is set, the recording paper P nipped between the pair of the discharging rollers 37 is directly discharged out of the main body of the printer. Then, the recording paper P is stacked at a stack portion forming the upper part of an upper cover 50 of the casing.

In the case of the duplex mode, when the rear end of the recording paper P transferred in the discharging paper path 36 while the front end thereof is nipped passes through the paper path 35 after fixing, the switching claw 42 rotates to the position indicated by a dotted line in FIG. 6 to close the portion around the end portion of the paper path 35 after fixing. At almost the same time, the pair of the discharging rollers 37 starts reverse rotation. Thus, the recording paper P is transferred with the rear end first and advances into the paper path 41 before reversing.

FIG. 6 is a front view of the printer. The front side relative to the direction orthogonal to the paper is the front side of the printer, and the rear end, the back side thereof. In addition, the right side in FIG. 6 is the right side of the printer and the left side, the left side thereof. The right end of the printer is a reversing unit 40 which can be open and close relative to the casing of the printer by rotating relative to a rotation axis 40a. When the pair of the discharging rollers 37 rotates reversely, the recording paper p advances into the paper path before reversing of the reverse unit 40 and is transferred from the upper to the bottom along the vertical direction. Then, by way of a pair of the reversing transfer rollers 43, the recording paper P moves into a paper reversing path 44. Furthermore, along the curvature form of the paper reversing path 44, the sides of the recording paper P are reversed and the moving direction from the top to the bottom is also reversed, meaning from the bottom to the top. After the paper path 31 described above, the recording paper P re-enters into the secondary transfer nip, where another full color toner image is secondarily transferred to the other side at one time. Then, the recording paper P passes through the paper path 33 after transfer, the fixing device 34, the paper path 35 after fixing, the discharging paper path 36, and the pair of the discharging rollers 37 and is discharged outside.

The reverse unit 40 described above includes an exterior cover 45 and a vibration body 46. Specifically, the exterior cover 45 of the reverse unit 40 is supported to rotate relative to the rotation axis 40a provided to the case of the main body of the printer. According to this rotation, the exterior cover 45 opens and closes against the case together with the vibration body 46 enclosed within the exterior cover 45. As illustrated in the dotted line, when the exterior cover 45 is opened together with the vibration body 46, the paper path 31, the secondary transfer nip, the paper path 33 after transfer, the fixing nip, the paper path 35 after fixing and the discharging paper path 36, which are structured between the reverse unit 40 and the main body of the printer, are separated in two in the vertical direction and exposed to the outside. Thereby, jammed paper in the paper path 31, the secondary transfer nip, the paper path 33 after transfer, the fixing nip, the paper path 35 after fixing and the discharging paper path 36 can be easily removed.

In addition, the vibration body 46 is supported by the exterior cover 45 in such a manner that the vibration body 45 rotates relative to the vibration axis (not shown) provided to the exterior cover 45 when the exterior cover 45 is open. By this rotation, when the vibration body 45 is open against the exterior cover 45, the paper path 41 before reversing and the paper reversing path 44 are separated in two in the vertical direction and exposed to the outside. Thereby, jammed paper in the paper path 41 before reversing and the paper reversing path 44 can be easily removed.

The upper cover 50 of the case of the printer is rotatably supported relative to a rotation axis 51 as indicated by the arrow in FIG. 6. When the upper cover 50 rotates counterclockwise in FIG. 6, the upper cover 50 opens relative to the case so that the upper part of the case is greatly exposed to the outside. Thereby, the optical writing unit 71 is exposed.

### Cleaning Device

FIG. 8 is an enlarged view illustrating the photoreceptor 2K and the drum cleaning device 3K in the process unit 1K for K. In FIG. 8, the drum cleaning device 3K functioning as a removing device of the toner remaining on the surface of the photoreceptor 2K as an image bearing member includes a retrieval screw 302K, a cleaning blade 303K, etc. in the casing 301K. The cleaning blade 303K is formed of elastic material and supported by a supporting board 304K at one end. The edge of the free end of the cleaning blade 303K is in contact with the photoreceptor 2K.

The supporting board 304K supporting the cleaning blade 303K at one end is fixed to an arm 305K. This arm 305K is rotatable relative to a revolution axis 306K and a rotation force counterclockwise is imparted to the arm 305K by the tensional force of a coil spring 307K. Thereby, a revolution force counterclockwise relative to the revolution axis 306K is imparted to the cleaning blade 303K supported by the arm 305K via the supporting board 304K. When the cleaning blade 304K revolves in some degree, the edge of the blade reaches the photoreceptor 2K and thus the cleaning blade 303K is made in contact with the photoreceptor 2K with a pressure in some degree.

The transfer residual toner scraped from the surface of the photoreceptor 2K by the cleaning blade 303K falls onto the retrieval screw 302K provided directly under the arm 305K. As the retrieval screw 302K is rotationally driven by a driving force (not shown), the residual toner is transferred along the axis direction of the retrieval screw 302 and discharged out of the drum cleaning device 3K. The discharged retrieval toner is transferred to a waste toner bottle by a transfer device (not shown).

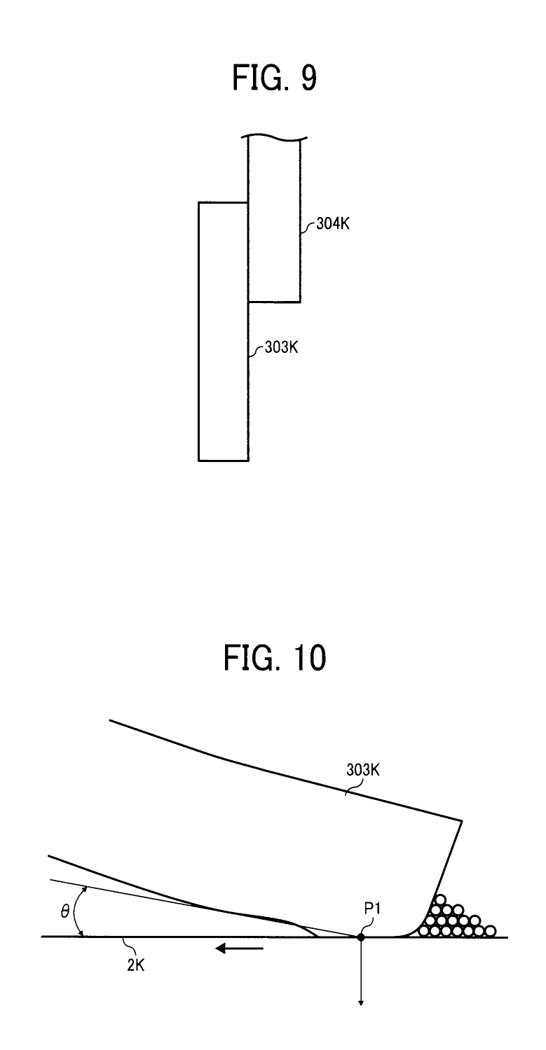

As illustrated in FIG. 9, the cleaning blade 303K is fixed and adhered to the supporting board 304. The supporting board 304K is made of metal, plastic, ceramic, etc. Preferred specific examples thereof are metal board such as stainless board, aluminum board, or phosphor bronze board since the supporting 304K is under a pressure to some extent.

In addition, the cleaning blade 303K is in contact with the photoreceptor 2K with a contact angle of E as illustrated in FIG. 10. This contact angle θ is an angle formed by the tangential line of the contact point P1 of the edge of the cleaning blade 303K and the photoreceptor 2K and the extension line of the photoreceptor 2K on the downstream side based on the moving direction of the photoreceptor 2K relative to the contact point P1. The contact angle θ is typically from 7 to 20° although depending on the cleaning system. In terms of the behavior at the contact point of the elastic blade, the contact angle is preferably from 10 to 15°.

### Elastic Blade

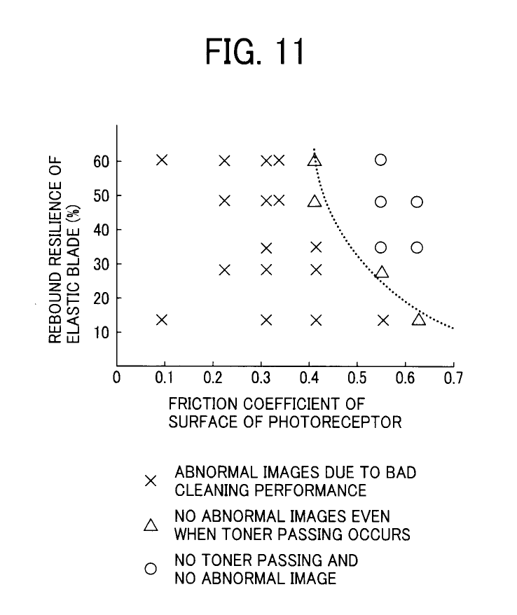

As the material for use in the elastic blade, it is possible to suitably select typical material for a board plate member such as resin, for example, thermoplastic resins such as urethane resins, styrene resins, olefin resins, vinyl chloride resins, polyester resins, polyamide resins, and fluorine resins. Among them, polyurethane rubber is particularly preferred. Polyurethane rubber is manufactured by preparing a polyurethane polymer using polyol and polyisocyanate, adding a curing agent to the resultant, placing the resultant in a die and curing the resultant by cross-linking followed by aging at room temperature. Preferred physicality of the elastic blade for use in the present invention is: hardness (60-80 according to JIS-A), extension (300-350%), perpetual extension (1.0 to 5.0%), 300% modulus (100 to 350 kg/cm²). As illustrated in FIG. 11, an elastic blade having a rebound resilience of from 35 to 40% achieves good cleaning performance. With regard to the behavior of the elastic blade due to the vibration at the contact portion with the photoreceptor, good responsiveness and scraping effect can be obtained by using an elastic blade having a high rebound resilience. In the structure for use in the present invention, an elastic blade having a rebound resilience of 80% is used to secure a sufficient cleaning property.

In particular, polyurethane is preferred as the material for the elastic blade for use in the present invention. There is no specific limit to the elastic blade available from the market.

The hardness and the rebound resilience are measured according to the measuring method described in JIS K6301 at the environment condition of 24° C. and 50% humidity.

The elastic blade is provided to a cleaning device while attached to a supporting member. There is no specific limit to the supporting member and metal, plastic, ceramic can be used therefor. Considering the stress applied to some extent, a metal board is preferred in particular. Especially, steel board such as SUS, aluminum board and phosphor bronze board are preferred.

In addition, the elastic blade is molded to have a form suitable for a cleaning blade for an image bearing member in a cleaning device generally installed in an image forming apparatus. There is no specific limit to the form as long as it is a blade form and the edge is in contact with an image bearing member. The thickness of the blade is typically from 1.5 to 2.5 mm. When the thickness is too thin, the vibration tends to be not stable, which may lead to bad cleaning. By contrast, a cleaning blade that is too thick easily makes the cleaning blade squeak.

### Image Bearing Member (Photoreceptor)

Next, the photoreceptor drum for use in the embodiment is described.

As the structure of the present invention, the organic electophotographic photosensitive layer of the image bearing member can be a single-layer structure or a multiple-layered structure of a charge generating layer and a charge transport layer.

The charge generating layer is formed of a charge generating material or a charge generating material and a binder resin and preferably has a thickness of from 0.05 to 3 μm.

Specific examples of such charging materials include, but are not limited to, C.I. Pigment Blue 25 (Color Index CI 21180), C.I. Pigment Red 41 (Color Index CI 21200), C.I. Acid Red 52 (Color Index C.I. 45100), C.I. Basic Red 3 (Color Index CI 45210), azo pigments such as azo pigments having carbazole skeleton, azo pigments having distyrylbenzene skeleton, azo pigments having triphenyl amine skeleton, azo pigments having dibenzothiophene skeleton, azo pigments having oxadiazole skeleton, azo pigments having fluorenone skeleton, azo pigments having bisstilbene skeleton, azo pigments having distyryloxadiazole skeleton or azo pigments having distyrylcarbazole skeleton; phthalocyanine pigments such as C.I. Pigment Blue 16 (Color Index CI 74100), indigo pigments such as C.I. Vat Blue (Color Index CI 73410) or C.I. Vat Dye (Color Index CI 73030); perylene pigments such as Algol Scarlet 5 (manufactured by Bayer Co.) or Indanthrene Scarlet R (manufactured by Bayer Co.), a squaric dye and hexagonal crystal Se powder.

These charge generating materials are pulverized and/or dispersed in a solvent such as tetrahydrofuran, cyclohexanone, dioxane and/or dichloroethane by using a ball mill, an attritor, or a sand mill. It is also possible to add resins such as polyamides, polyurethanes, polyesters, epoxy resins, polyketones, polycarbonates, silicone resins, acryl resins, polyvinyl butyral, polyvinyl formal, polyvinyl ketone, polystyrene, poly-N-vinyl carbazole, or polyacryl amides as a binding agent.

As the charge transport materials, there are used compounds having polycyclic aromatic compounds such as anthracene, pyrene, phenanthrene or coronene or nitrogen containing cyclic compounds such as indole, carbazole, oxazole, isooxazole, thiazole, imidazole, pyrazole, oxadiazole, pyrazoline, thiadiazole, or triazole in their main chain or branch chain, triphenyl amine compounds, hydrazone compounds and α-phenyl stilbene compounds.

These charge transport materials are dissolved in a solvent such as polystyrene, copolymers of styrene and acrylonitrile, copolymers of styrene and butadiene, copolymers of styrene and maleic anhydride, polyesters, polyvinyl chlorides, copolymers of vinyl chloride and vinyl acetate, polyvinyl acetate, polyvinylidene chloride, polyarylate dioxane, and/or dichloroethane to prepare liquid of forming a charge transport layer. The liquid is spray-coated followed by preliminary and primary drying to form a charge transport layer.

The organic electrophotographic photosensitive layer of a multiple layer type of a charge generating layer and a charge transport layer has been described so far but the organic electrophotographic photosensitive layer can be single-layer structured. In addition, it is also possible to provide an optional undercoating layer between the electroconductive substrate and its adjacent layer, i.e., the charge transport layer or the charge generating layer.

A material selected from the resins specified as the binder resin for the charge generating layer can be used for an undercoating layer and furthermore, it is also possible to add white pigment such as titanium oxides, sulfonic acid or an anion based electroconductive polymer formed of, such as alkali metal salts or ammonium salts of sulfonic acid. It is preferred to select a material which is insoluble in the solvent for use in the liquid of forming a layer coated on the undercoating layer.

Materials having a volume resistance of not greater than 10¹⁰ Ω·cm can be used as a photoreceptor tube. For example, there can be used plastic or paper having a film form or cylindrical form covered with a metal, such as aluminum, nickel, chrome, nichrome, copper, gold, silver, and platinum, or a metal oxide, such as tin oxide and indium oxide by depositing or sputtering. Also a board formed of aluminum, an aluminum alloy, nickel, and a stainless metal can be used. Further, a tube which is manufactured from the board mentioned above by a crafting technique, for example, extruding and extracting, and surface-treatment, such as cutting, super finishing and grinding, is also usable. In the present invention, aluminum is used. The tube thickness t in the structure of the embodiment is arranged along the inner diameter direction of the tube with the outer diameter thereof fixed.

### Toner

In the present invention, a toner having a volume average particle diameter of from 5 to 10 μm (measured by Multisizer III manufactured by Beckman Coulter Co., Ltd.) is preferred considering the impact on the image quality. Thus, a toner having a volume particle diameter of 8 μm is used. In addition, to maintain and improve the separability (releasability) of transfer paper and the fixing device when a toner image formed on a transfer paper is fixed, mother toner material includes a releasing component.

For the toner particle of the toner for forming a full color image of the present invention, the first binder resin in which hydrocarbon wax is internally added, the second binder resin, a coloring agent, a charge control agent and external additives, which are described later in detail, are preferably used.

### Binder Resin

The kind of the first binder resin and the second binder resin is not specifically limited. For example, there can be used typical binder resins in the full color toner field such as polyester resins, (meth)acryl resins, styrene-(meth) acryl based copolymer resin, epoxy resins, COC (cyclic olefin resins) such as TOPAS-COC (manufactured by Ticona of Celanese Corporation). However, it is preferred to use polyester resins for both the first binder resin and the second binder resin in light of oil-free fixing.

As the polyester resins preferably used for the present invention, polyester resins obtained by polycondensation of polyalcohol component and polycarboxylic acid component can be used. Specific examples of dialcohol component among the polyalcohol component include, but are not limited to, adducts of bisphenol A with an alkylene oxide such as polyoxypropylene(2,2)-2,2-bis(4-hydroxyphenyl)propane, polyoxypropylene(3,3)-2,2-bis(4-hydroxyphenyl)propane, polyoxypropylene(6)-2,2-bis(4-hydroxyphenyl)propane, polyoxyethylen(2,0)-2,2-bis(4-hydroxyphenyl)propane, ethylene glycol, diethylene glycol, triethylene glycol, 1,2-propylene glycol, 1,3-propylene glycol, 1,4-butandiol, neopentl glycol, 1,4-butene diol, 1,5-pentane diol, 1,6-hexane diol, 1,4-cyclohexane dimethanol, dipropylene glycol, polyethylene glycol, polytetramethylene glycol, bisphenol A and hydrogenerated bisphenol A. Specific examples of tri or higher alcohol components include, but are not limited to, sorbitol, 1,2,3,6-hexane tetrol, 1,4-sorbitan, pentaerythritol, dipentaerythritol, tripentaerythritol, 1,2,4-butane triol, 1,2,5-pentane triol, glycerol, 2-methyl propane triol, 2-methyl-1,2,4-butane triol, trimethylol ethane, trimethylol propane, and 1,3,5-trihydroxy methyl benzene.

In addition, specific examples of dicarboxylic acids among the polycarboxylic acids include, but are not limited to, maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, malonic acid, n-dodecenyl succinic acid, isododecenyl succinic acid, n-dodecyl succinic acid, isododecyl succinic acid, n-octenyl succinic acid, isooctenyl succinic acid, n-octyl succinic acid, isooctyl succinic acid, and anhydrides or lower alkyl esters thereof.

Specific examples of tri- or higher carboxylic acids include, but are not limited to, 1,2,4-benzenetricarboxylic (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, 1,2,4-cyclohexane tricarboxylic acid, tetra(methylene carboxyl)methane, 1,2,7,8-octane tetra carboxylic acid, pyromellitic acid, EnPol trimer acid, and anhydrides or lower alkyl esters thereof In the present invention, a mixture of a material monomer of a polyester (-based) resin, a material monomer of a vinyl (-based) resin and a monomer reactive with both material monomers is used to obtain a suitable resin (hereinafter referred to as vinyl based polyester resin) by conducting a polycondensation reaction to obtain a polyester resin and a radical polyemerization reaction to obtain a vinyl resin in the same vessel. The monomer reactive with both material monomers is a monomer usable for both polycondensation reaction and radical polymerization reaction, that is, a monomer having a carboxyl group which can conduct a polycondensation reaction and a vinyl group which can conduct a radical polymerization reaction. Specific examples thereof include, but are not limited to, fumaric acid, maleic acid, acrylic acid, and methacrylic acid.

Specific examples of the material monomers of the polyester resins include, but are not limited to, the polyalcohols and polycarboxylic acids mentioned above.

Specific examples of the material monomers of the vinyl resins include, but are not limited to, styrene or derivatives thereof such as o-methyl styrene, m-methyl styrene, p-methyl styrene, α-methyl styrene, p-ethyl styrene, 2,4-dimethyl styrene, p-tert-butyl styrene, and p-chlorostyrene; ethylene based unsaturated mono-olefins such as ethylene, propylene, butylene, and isobutylene; alkyl methacrylates such as methyl methacrylate, n-propyl methacrylate, isopropyl methacrylate, n-butyl methacrylate, isobutyl methacrylate, t-butyl methacrylate, n-pentyl methacrylate, isopentyl methacrylate, neopentyl methacrylate, 3-(methyl)butyl methacrylate, hexyl methacrylate, octyl methacrylate, nonyl methacrylate, decyl methacrylate, undecyl methacrylate, and dodecyl methacrylate; alkyl acrylates such as methyl acrylate, n-propyl acrylate, isopropyl acrylate, n-butyl acrylate, isobutyl acrylate, t-butyl acrylate, n-pentyl acrylate, isopentyl acrylate, neopentyl acrylate, 3-(methyl)butyl acrylate, hexyl acrylate, octyl acrylate, nonyl acrylate, decyl acrylate, undecyl acrylate, and dodecyl acrylate; unsaturated carboxylic acids such as acrylic acid, methacrylic acid, itaconic acid and maleic acid; acrylonitrile, esters of maleic acid, esters of itaconic acid, vinyl chloride, vinyl acetate, vinyl benzoate, vinylmethyl ketone, vinylhexyl ketone, vinylmethyl ether, vinylethyl ether, and vinylisobutyl ether.

Specific examples of the polymerization initiators to polymerize the material monomer of vinyl based resins include, but are not limited to, azo-based or diazo-based polymerization initiators such as 2,2′-azobis(2,4-dimethyl valero nitrile, 2,2′-azobisisobutylo nitrile, 1,1′azobis(cyclohexane-1-carbonitrile), and 2,2′-azobis-4-methoxy-2,4-dimethyl valero nitrile, and peroxide-based polymerization initiators such as benzoyl peroxide, dicumyl peroxide, methylethyl ketone peroxide, isopropyl peroxy carbonate, and lauroyl peroxide.

The polyester resins mentioned above are preferably used as the first binder resin and the second binder resin. Among these, in terms of improvement on releasability and anti-offset property as the toner for oil free fixing, it is more preferred to use the following first binder resin and second binder resin in combination.

More preferred first binder resins are polyester resins obtained by polycondensation of the polyalcohol component and polycarboxylic acid component mentioned above. Especially, the polyester resin prepared by using an adduct of bisphenol A with alkylene oxide as the polyalcohol component and terephthalic acid and fumaric acid as the polycarboxylic acid components is particularly preferred.

More preferred second binder resins are vinyl based polyester resins which are obtained by using an adduct of bisphenol A with alkylene oxide, terephthalic acid, trimellitic acid and succinic acid as the material monomer for the polyester resin, styrene and butyl acrylate as the material monomer for the vinyl based monomer and fumaric acid as the monomer reactive with both material monomers in particular.

In the present invention, it is preferred to internally add a hydrocarbon wax when the first binder resin is synthesized. To internally add a hydrocarbon wax to the first binder resin in advance, it is suitable to synthesize the first binder resin from the state in which a hydrocarbon wax is added in a monomer used for synthesizing the first binder resin. For example, it is good to conduct polycondensation reaction from a state in which a hydrocarbon wax is added to an acid monomer or an alcohol monomer forming a polyester resin as the first binder resin. When the first binder resin is a vinyl-based polyester resin, it is suitable to conduct polycondensation reaction and radical polymerization reaction by dropping a material monomer for a vinyl resin to a mixture in which a hydrocarbon wax is added to a material monomer for the polyester resin while stirring and heating the monomer.

### Releasing Agent (Wax)

In general, wax having a low polarity has an excellent releasing property with regard to a fixing roller. Therefore, the wax for use in the present invention is preferably a hydrocarbon wax having a low polarity. The hydrocarbon wax represents a wax containing only carbon atoms and hydrogen atoms and thus ester group, alcohol group, or an amide group is not contained therein.

Specific examples of the hydrocarbon waxes include, but are nor limited to, polyolefin waxes such as polyethylene, polypropylene, copolymers of ethylene and propylene, oil waxes such as paraffin wax and microcrystalline wax, and synthesized waxes such as Fisher-Tropsch wax. Among these, polyethylene wax, paraffin wax and Fisher-Tropsch wax are preferred. Polyethylene wax and paraffin wax are more preferred.

### Wax-Dispersing Agent

The toner of the present invention may include a wax dispersion agent to improve dispersion of wax. There is no specific limit to wax dispersion agents and any known dispersion agents can be used. Specific examples of such wax dispersion agents include, but are not limited to, polymers or oligomers in which a unit highly compatible with wax and a unit highly compatible with a resin are present as a block body, polymers or oligomers in which one of a unit highly compatible with wax and a unit highly compatible with a resin grafts to the other, copolymers of unsaturated hydrocarbons such as ethylene, propylene, butane, styrene, and α-styrene and α,β-unsaturated carboxylic acid such as acrylic acid, methacrylic acid, maleic acid, maleic anhydride, itaconic acid and itaconic anhydride, esters thereof or anhydrides thereof, block bodies or graft bodies of a vinyl based resin and a polyester.

Specific examples of the unit highly compatible with the wax mentioned above include long chain alkyl groups having 12 or more carbon atoms, polyethylene, polypropylene, polybutene, polybutadiene, and copolymers thereof. As the unit highly compatible with resins, there are polyesters and vinyl based resins.

The content of the releasing agent is preferably from 3 to 10 parts by weight, more preferably from 4 to 8 parts by weight and particularly preferably from 5 to 7 parts by weight.

### Charge Control Agent

Known charge control agents can be used.

Specific examples thereof include, but are not limited to, Nigrosine dyes, triphenylmethane dyes, metal complex dyes including chromium, chelate pigments of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples of the marketed products of the charge control agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. Among these, a compound that controls to negatively charge toner particles is preferred.

The content of the charge control agent is determined by the kind of the binder resin, optional additives, and method of manufacturing toner including dispersion method. The range of the content of the charge control agent is from 0.1 to 10 parts by weight and preferably from 0.2 to 5 parts by weight based on 100 parts by weight of the binder resin. When the content is too large, the toner is easily charged, which leads to deterioration of the charge control effect. Therefore, the electrostatic suction force with the development roller increases, which may result in deterioration of the fluidity of the development agent or decrease in image density. Suitable coloring agents for use in the toner of the present invention include known dyes and pigments.

Specific examples of the coloring agents include carbon black, Nigrosine dyes, black iron oxide, Naphthol Yellow S, Hansa Yellow (10G, SG and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux SB, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination.

The content of the coloring agent in the toner in the present invention is preferably from 1 to 15% by weight, and more preferably from 3 to 10% by weight, based on the total weight of the toner.

### Master Batch of Coloring Agent

Master batch pigments, which are prepared by combining a coloring agent with a resin, can be used as the coloring agent of the toner composition in the present invention. Specific examples of the resins for use in the master batch pigments or for use in combination with master batch pigments include, but are not limited to, in addition to the polyester resin and the vinyl based resins mentioned above, rosin, modified rosins, terpene resins, aliphatic or alicyclic hydrocarbon resins, aromatic petroleum resins, chlorinated paraffin, and paraffin waxes. These resins can be used alone or in combination.

### External Additive

In the present invention, it is preferred to use at least one kind of inorganic particulates as an external additive to assist the fluidity, developability and transferability of toner particles.

The specific surface area of the inorganic particulate according to BET method is preferably from 30 to 300 m²/g. The primary particle diameter thereof is preferably from 10 to 50 nm. A primary particle diameter that is too large makes the inorganic particulates fixed in mother toner particles (i.e., toner particles to which external additives are not attached yet), which significantly has an adverse impact on the image quality due to the release of the external additive. In addition, when the primary particle diameter is too small, such inorganic particulates tend to be embedded in mother toner particles, which causes deficiency of the durability.

Specific examples of such inorganic particulates include, but are not limited to, silica, zinc oxide, tin oxide, quartz sand, titanium oxide, clay, mica, sand-lime, diatom earth, chromium oxide, cerium oxide, red iron oxide, antimony trioxide, magnesium oxide, alumina, zirconium oxide, barium sulfate, barium carbonate, calcium carbonate, silicon carbide, and silicon nitride.

The total amount of the external additive in the present invention is preferably from 2.5 to 4.0 parts by weight based on 100 parts by weight of mother toner (mother toner particles). When the content of the external additive is too large, anti-mottle, developability, fixing separability, etc. tend to deteriorate. When the content of the external additive is too small, fluidity, transferability and high temperature preservability of the toner tend to deteriorate.

Particularly, as the fluidizer to assist improving fluidity of toner particles, silica (silicon dioxide) is preferred. The attachment strength of the fluidizer to mother toner (mother toner particle) is preferably from 30 to 80%. When the attachment strength is too small, the ratio of the external additives fixed in or on the mother toner (mother toner particle) tends to decrease so that separated external additives have an adverse impact on the image quality. When the attachment strength is too large, the external additive is easily embedded in mother toner (mother toner particle) so that the spacer effect weakens.

### Attachment Strength of External Additive

After 2 g of toner is placed in 30 cc of a surface active agent diluted 10 times is sufficiently settled, ultrasonic wave homogenizer is used to impart an energy of 40 W for one minute thereto. Subsequent to treatment of separation, washing and drying of the toner, the ratio of the amount of attachment of the inorganic particulates before and after the treatment is calculated by a fluorescent X ray analyzer. Fluorescent X ray analysis is performed by wavelength-dispersive fluorescent X ray analyzer (XRF1700, manufactured by Shimadzu Corporation). In the analysis, the force of 1 N/cm² is applied for 60 seconds to 2 g of each of the dried toner obtained by the treatment and the toner prior to the treatment to prepare a toner pellet. Then, the quantity of the element unique to the inorganic external additives, for example, silicon in silica, is determined by a calibration curve method.

As a result, it is found that the fluidizer preferably has an attachment strength to mother toner (mother toner particle) of from 30 to 80%. When the attachment strength is too weak, the ratio of the external additives fixed in or on the mother toner (mother toner particle) tends to decrease so that detached external additives have an adverse impact on the image quality. When the attachment strength is too strong, the external additives are easily embedded in mother toner (mother toner particle) so that the spacer effect weakens.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Examples 1 to 7 and Comparative Examples 1 to 6

### Preparation of First Binder Resin H1

The following recipe is placed in a dripping funnel.

| | |
|---|---|
| Styrene (Vinyl(-based) monomer) | 600 g |
| Butyl acrylate | 110 g |
| Acrylic acid | 30 g |
| Dicumyl peroxide (polymerization initiator) | 30 g |

Next, the following recipe is placed in a flask equipped with a thermometer, a stainless stirrer, a flow-down condenser and a nitrogen introducing tube.

| | |
|---|---|
| Polyoxypropylene (2,2)-2,2-bis(4-hydroxyphenyl)propane | 1,230 g |
| (polyol of polyester monomer) | |
| Polyoxyethylene (2,2)-2,2-bis(4-hydroxyphenyl)propane | 290 g |
| (polyol of polyester monomer) | |
| Isododecenyl succinic anhydride | 250 g |
| Terephthalic acid | 310 g |
| Anhydride of 1,2,4-benzene tricarboxylic acid | 180 g |
| Dibutyl tin oxide (esterification catalyst) | 7 g |

Paraffin releasing agent (melting point: 73.3° C., half value width of endothermic peak at temperature rising: 4° C., measured by a differential scanning calorimeter) parts by weight shown in “amount of internally added wax” in Table 1 based on 100 parts of the monomer

The mixture of the vinyl(-based) monomer resin and the polymerization initiator is dropped from the dripping funnel to the flask in one hour in a mantle heater in nitrogen atmosphere while stirred at 160° C. While keeping the temperature at 160° C., reaction of addition polymerization is conducted for 2 hours and settled. Then, the system is heated to 230° C. to conduct condensation polymerization. The polymerization degree is traced by the softening point measured by a constant load extruding fine tublar rheometer and the reaction is finished at a desired softening point to obtain a resin H1. Each of the obtained resins has a softening point of 130° C.

### Preparation of Second Binder Resin L1

The following recipe is placed in a flask equipped with a thermometer, a stainless stirrer, a flow-down condenser and a nitrogen introducing tube and heated to 230° C. in a mantle heater in nitrogen atmosphere to conduct a condensation polymerization reaction.

| | |
|---|---|
| Polyoxypropylene (2,2)-2,2-bis(4-hydroxyphenyl)propane | 2,210 g |
| (polyol) | |
| Terephthalic acid | 850 g |
| Anhydride of 1,2,4-benzene tricarboxylic acid | 120 g |
| Dibutyl tin oxide (esterification catalyst) | 0.5 g |

The polymerization degree is traced by the softening point measured by a constant load extruding fine tublar rheometer and the reaction is finished at a desired softening point to obtain a resin L1. The resin has a softening point of 115° C.

### Preparation 1 of Toner Particles—Pre-Mixing

A master batch containing C. I. Pigment Red 57-1 with an amount ratio of 4 parts by weight based on 100 parts by weight of the binder resin formed of the first binder resin and the second binder resin with a ratio of H1:L1=60:40 and a paraffin releasing agent in an amount (parts by weight) shown in “amount of externally added wax” in Table 1 are sufficiently mixed by a HENSCHEL MIXER to obtain a dry blend material.

### Preparation 2 of Toner Particles—Mixing and Kneading

Mixing and kneading is performed by either of the kneading machines of (1) and (2) described below.

### (1) Mortar Type Kneading Machine (Stone Mill)

The mixture is mixed and kneaded by a mortar type kneading machine (stone mill) with a supply amount of 95 kg/h, a screw rotation speed of 85 rpm, and a control temperature of 10° C. at the furnishing unit (F), 125° C. at the barrel units (K1-K4), 100° C. at the vent unit (V), and 100° C. at the dice unit (D). The obtained kneaded product is extended by applying pressure by a cooling press roller until the thickness thereof is 2 mm. Subsequent to cooling by a cooling belt, the resultant is coarsely pulverized by a feather mill.

### (2) Two Open Roll Type (OR)

The mixture is mixed and kneaded by an open roll type kneading machine (manufactured by Mitsui Mining Co., Ltd.) at a mixing and kneading temperature (temperature at the heating roll on the material furnishing side) of 120° C. The obtained kneaded product is cooled down by a cooling belt and then coarsely pulverized by a feather mill.

### Preparation 3 of Toner Particle—Pulverization Classification and External Addition

Thereafter, the product is pulverized by a mechanical pulverizer (KTM, manufactured by Kawasaki Heavy Industries, Ltd.) until the average particle diameter thereof is from 10 to 12 um. Furthermore, the resultant is coarsely pulverized by a jet type pulverizer (IDS, manufactured by Nippon Pneumatic Mfg. Co., Ltd.) while coarsely classified. Then, the obtained product is finely classified by a rotor type classifier (Turbo-plex type classifier: 100 ATP, manufactured by Hosokawa Micron Group) to obtain a colored resin particle 1 having a volume average particle diameter of 9.0 μm. One part of inorganic particulate of Cab-O-Sil® TS530 (manufactured by Cabot Corporation) and one part of inorganic particulate of OX50 (manufactured by Evonik Industries) are externally added to 100 parts of this colored resin particle 1. After mixing treatment for 10 minutes by a 10L HENSCHEL MIXER at a circumferential speed of 40 m/s, a magenta toner particle 1 is obtained.

### Evaluation on Blade Squeak and Cleaning Property

The elastic blade and the toner for use in the present invention are used in a machine remodeled based on a printer (ipsio CX3000, manufacture by Ricoh Co., Ltd.). The combination of the elastic blade and the toner in which squeak of the blade occurs during a continuous run length of 5,000 sheets with a chart of 5% is evaluated as bad and, no squeak, as good.

In addition, the toner attachment on the photoreceptor after cleaning is observed by a CCD microscope camera (hyper microscope, manufactured by Keyence Corporation) to evaluate the cleaning property. The combination in which toner slips through the blade during cleaning is evaluated as bad, and in which toner does not slip through the blade during cleaning is evaluated as good.

The evaluation results of the blade squeak and the cleaning property are shown in Table 1 below.

### Fixing Property, Fixing Winding

A two component developing agent prepared by mixing and stirring 5 parts of the toner and 95 parts of silicone resin coated carrier is set in a machine remodeled by removing the fixing device from ipsio CX7500 (manufactured by Ricoh Co., Ltd.). A solid image having a 3 mm margin on the front end along the portrait direction is printed on six transfer sheets (TYPE6200 perpendicular to machine direction, manufactured by Ricoh Co., Ltd.) with a toner development density of from 1.0 to 1.2 mg/cm². Six transfer sheets are output in total in unfixed state.

The fixing portion is extracted out from an IPSIO CX 2500 (manufactured by Ricoh Co., Ltd.) and remodeled to have a desired belt temperature and a belt linear speed. Rhe images on the transfer sheets are fixed by this remodeled fixing device from the front end margin at a belt linear speed of 125 mm/sec and a fixing belt temperature of from 140 to 190° C. with an interval of 10° C. Fixing is evaluated according to the following criterion, which is the number of the transfer sheets on which the image has been successfully fixed without the transfer sheet being wound round the fixing belt or accordion-folded and stuck at the exit of the fixing device. The evaluation results on fixing are shown in Table 1.

### Evaluation Criterion

Good: Number of successfully fixed transfer sheets: 5 or more

Bad: Number of successfully fixed transfer sheets: 4 or less

### Development Fixation Evaluation

The image quality is evaluated by using a color laser printer ipsio CX3000 (manufactured by Ricoh Co., Ltd.) for 2,000 sheets in a mode in which a break is taken between each image print at HH environment (27° C./80%) for the toners while replacing the toners. The image having a white streak ascribable to fixation of the regulating blade during black solid image formation is evaluated as bad, and the image free from a white streak is evaluated as good. The evaluation results on development fixation are shown in Table 1.

TABLE 1

| | | | | Manufacturing Conditions | | | | | | |
|---|---|---|---|---|---|---|---|---|---|---|
| | | | | | | Amount | | | | |
| | | | | | | of | | | | |
| | | | | | | externally | | | | |
| | | | | Kneading | Amount of | added | | | | |
| | | | | machine | H1 internally | wax | | | | |
| | WA | | | (OR: | added wax | (parts | Evaluation | | | |
| | (%) | T | T (mm) | Open | (parts by | by | Blade | Cleaning | | Development |
| | (45-60) | (mNm) | (1.2-2.0) | Roll) | weight) | weight) | squeak | performance | Fixability | fixation |
| Example 1 | 52 | 1.8 | 1.6 | Mortar | 7.5 | 0 | Good | Good | Good | Good |
| Example 2 | 45 | 1.0 | 1.2 | OR | 0 | 3 | Good | Good | Good | Good |
| Example 3 | 48 | 1.3 | 2.0 | OR | 10 | 0 | Good | Good | Good | Good |
| Example 4 | 60 | 2.5 | 2.0 | Mortar | 10 | 0 | Good | Good | Good | Good |
| Example 5 | 45 | 1.0 | 1.2 | OR | 0 | 3 | Good | Good | Good | Good |
| Example 6 | 45 | 1.9 | 1.6 | Mortar | 0 | 4 | Good | Good | Good | Good |
| Example 7 | 60 | 1.6 | 1.8 | OR | 0 | 6 | Good | Good | Good | Good |
| Comparative | 45 | 1.0 | 1.6 | OR | 0 | 3 | Good | Bad | Good | Good |
| Example 1 | | | | | | | | | | |
| Comparative | 60 | 2.5 | 1.6 | Mortar | 10 | 0 | Bad | Good | Good | Good |
| Example 2 | | | | | | | | | | |
| Comparative | 52 | 1.8 | 2.1 | Mortar | 7.5 | 0 | Good | Bad | Good | Good |
| Example 3 | | | | | | | | | | |
| Comparative | 52 | 1.8 | 1.1 | Mortar | 7.5 | 0 | Bad | Good | Good | Good |
| Example 4 | | | | | | | | | | |
| Comparative | 42 | 1.4 | 1.4 | Mortar | 5 | 0 | Good | Good | Bad | Good |
| Example 5 | | | | | | | | | | |
| Comparative | 62 | 2.0 | 1.5 | OR | 0 | 6 | Good | Good | Good | Bad |
| Example 6 | | | | | | | | | | |

As seen in the results of Examples 1 and 7 and Comparative Examples 1 to 6, according to the present invention, an image forming apparatus, a process cartridge, an image formation method and the single component toner for use in the image forming apparatus can be provided in which toner attachment force is decreased, the amount of accumulating toner is reduced and leading to the phenomenon of blade squeak is restrained, resulting in good cleaning performance even when images are formed with the wax containing pulverized toner having a low average circularity.

This document claims priority and contains subject matter related to Japanese Patent Application No. 2007-217151, filed on Aug. 23, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming apparatus comprising:
an image bearing member comprising a tube, the image bearing member configured to bear a latent electrostatic image;
a development device comprising a pulverized toner comprising a resin, a coloring agent and a releasing agent component, the development device configured to develop the latent electrostatic image with the toner to form a visualized image on the image bearing member;
a transfer device configured to transfer the visualized image to a recording medium;
a fixing device comprising a fixing member, the fixing device configured to fix the visualized image on the recording medium; and
an elastic blade configured to remove the toner on a surface of the image bearing member,
wherein the toner has a void ratio of from 52 to 58% and a toner torque of from 1.0 to 2.5 mNm according to a torque measuring method using a circular conical rotor and following relationships (1) to (4) are satisfied:
45≦WA≦60 Relationship (1)
2×WA−40≦50×T≦2×WA+5 Relationship (2)
1.2≦t≦2.0 Relationship (3)
40×T−70≦15×t≦40×T−22 Relationship (4)
where WA (%) represents a surface exposure amount of the releasing agent component of the toner, T (mNm) represents the toner torque at 58% of the void ratio and t (mm) represents a thickness of the tube.

2. The image forming apparatus according to claim 1, wherein the toner has an average circularity of from 0.890 to 0.940.

3. The image forming apparatus according to claim 1, wherein the toner has a volume average particle diameter of from 5 to 10 μm.

4. The image forming apparatus according to claim 1, wherein the elastic blade comprises an elastic body having a rebound resilience of from 40 to 80% at 25° C.

5. The image forming apparatus according to claim 1, wherein a contact portion of the elastic blade and the image bearing member has a linear pressure of from 20 to 30 N/m.

6. The image forming apparatus according to claim 1, wherein the toner is manufactured by melting, mixing and kneading a dry blend material as a raw material by a mortar type kneading machine followed by pulverization.

7. The image forming apparatus according to claim 1, wherein the releasing agent component is a resin comprising the releasing agent.

8. The image forming apparatus according to claim 1, wherein the releasing agent component is the releasing agent and the releasing agent is from 3 to 10 parts by weight based on 100 parts by weight of mother toner particles.

9. The image forming apparatus according to claim 1, wherein the toner comprises an external additive having a primary particle diameter of from 10 to 50 nm.

10. The image forming apparatus according to claim 9, wherein the external additive is silica and has an attachment strength to the toner of from 30 to 80%.

11. The image forming apparatus according to claim 1, wherein the fixing device is a two roll fixing device comprising a heating roller and a pressing roller.

12. The image forming apparatus according to claim 1, wherein the fixing device is an oil free fixing device in which oil is not applied to the fixing member.

13. A process cartridge comprising:
an image bearing member comprising a tube, the image bearing member configured to bear a latent electrostatic image; and
an elastic blade configured to remove a toner on a surface of the image bearing member,
wherein the toner is a pulverized toner comprising a resin, a coloring agent and a releasing agent component and has a void ratio of from 52 to 58% and a toner torque of from 1.0 to 2.5 mNm according to a torque measuring method using a circular conical rotor and following relationships (1) to (4) are satisfied:
45≦WA≦60 Relationship (1)
2×WA−40≦50×T≦2×WA+5 Relationship (2)
1.2≦t≦2.0 Relationship (3)
40×T−70≦15×t≦40×T−22 Relationship (4)
where WA (%) represents a surface exposure amount of the releasing agent component of the toner, T (mNm) represents the toner torque at 58% of the void ratio and t (mm) represents a thickness of the tube.

14. An image formation method using the image forming apparatus of claim 1.

15. A single component toner for use in the image forming apparatus of claim 1.
